(19) United States
(12) Patent Application Publication
(10) Pub. No.: US 2024/0391255 A1
(43) Pub. Date: Nov. 28, 2024

(54) DRYING DEVICE AND AIR BLOWING DEVICE

(71) Applicant: CANON KABUSHIKI KAISHA, Tokyo (JP)

(72) Inventors: JUN KAWAKITA, Chiba (JP); YUTAKA NISHIMURA, Tokyo (JP); HIROSHI KOKUBO, Tokyo (JP); HIROKI KAJITA, Saitama (JP); YOSHIAKI HARA, Chiba (JP); KOHEI AOKI, Chiba (JP); YUSHI SADAMITSU, Tokyo (JP)

(21) Appl. No.: 18/635,261

(22) Filed: Apr. 15, 2024

(30) Foreign Application Priority Data
May 24, 2023 (JP) 2023-085247

(51) Int. Cl. B41J 11/00; B41J 13/08; B41J 29/13; B65H 5/22

(52) U.S. Cl. CPC B41J 11/0022; B41J 11/0024; B41J 11/0085; B41J 13/08; B41J 29/13; B65H 5/224; B65H 2301/5143; B65H 2404/255

(57) ABSTRACT

A drying device includes a sheet conveyance portion, a warm air blowing portion disposed above and opposite to the sheet conveyance portion and to blow a warm air from a nozzle on the sheet. A first casing accommodates the warm air blowing portion and a second casing accommodates the sheet conveyance portion. The first casing is movable to a closed position opposite to the sheet conveyance portion and an open position for opening the sheet conveyance portion. The first casing positioned in the closed position moves to the open position by being moved upward to the second casing in a vertical direction, and the warm air blowing portion is movable to the first casing in the vertical direction in a state in which the first casing is positioned in the open position.

### FIELD OF THE INVENTION AND RELATED ART

The present invention relates to a drying device for drying a sheet on which an image has been formed by ink, and relates to an air blowing device for blowing air onto the sheet.

In an image forming system which forms an image by ink, there is a process of drying a sheet or a process of blowing air onto a sheet. For example, in Japanese Laid-Open Patent Application (JP-A) 2009-226812, a drying device, in which a sheet is conveyed by a belt and the sheet is dried by blowing warm air to the sheet, is proposed.

Here, a drying device, etc. includes a sheet conveyance portion in which a sheet is conveyed, and a warm air blowing portion or an air blowing portion (hereinafter, referred to as a warm air blowing portion, etc.) which blows warm air or air to the sheet which is conveyed by the sheet conveyance portion. In such a drying device, there may be a case that some components are replaced, and in a case that only some components are replaced, it may not be possible to guarantee functions of a unit which includes the components after replacement of the components.

A principal object of the present invention is to provide a configuration in which functions after replacement of components are easily guaranteed.

### SUMMARY OF THE INVENTION

According to an aspect of the present invention, there is provided a drying device comprising: a sheet conveyance portion configured to convey a sheet; a warm air blowing portion disposed above with respect to a vertical direction and opposite to the sheet conveyance portion, and configured to blow a warm air from a nozzle on the sheet conveyed by the sheet conveyance portion; a first casing configured to accommodate the warm air blowing portion; and a second casing configured to accommodate the sheet conveyance portion, wherein the first casing is movable to a closed position opposite to the sheet conveyance portion and an open position for opening the sheet conveyance portion, wherein the first casing positioned in the closed position moves to the open position by being moved upward to the second casing with respect to the vertical direction, and the warm air blowing portion is movable to the first casing in the vertical direction in a state in which the first casing is positioned in the open position.

Further features of the present invention will become apparent from the following description of exemplary embodiments with reference to the attached drawings.

### BRIEF DESCRIPTION OF THE DRAWINGS

FIG. 1 is a perspective view showing a schematic configuration of an image forming system according to a first embodiment of the present invention.

FIG. 2 is a sectional view showing a schematic configuration of a drying module according to the first embodiment.

FIG. 3 is a perspective view showing the drying module according to the first embodiment, while an upper door is open.

FIG. 4 is a perspective view showing a warm air blowing unit according to the first embodiment, when a part of the warm air blowing unit is cut.

FIG. 5 is a sectional view showing a schematic configuration of the warm air blowing unit according to the first embodiment.

FIG. 6 is a plan view showing a warm air blowing surface of the warm air blowing unit according to the first embodiment.

FIG. 7 is a perspective view showing a cold air blowing unit according to the first embodiment, when a part of a cold air blowing unit is cut.

FIG. 8 is a sectional view showing a schematic configuration of the cold air blowing unit according to the first embodiment.

FIG. 9 is a perspective view showing the upper door when it is viewed from below.

FIG. 10 is a view showing a state that the warm air blowing unit according to the first embodiment is being removed from the upper door.

FIG. 11 is a partially enlarged view showing the state that the warm air blowing unit according to the first embodiment is being removed from the upper door.

FIG. 12 is a view showing a state that the cold air blowing unit according to the first embodiment is being removed from the upper door.

FIG. 13 is a perspective view showing a locking mechanism according to the first embodiment.

FIG. 14 is an enlarged perspective view showing the locking mechanism according to the first embodiment.

Part (a) of FIG. 15 is a plan view and part (b) of FIG. 15 is a sectional view illustrating an operation of a lock lever according to the first embodiment.

FIG. 16 is a perspective view showing a drying module according to a second embodiment, while an upper door is open.

FIG. 17 is a view showing a state that the warm air blowing unit according to the first embodiment is being removed from a lower side casing.

### DESCRIPTION OF THE EMBODIMENTS

### First Embodiment

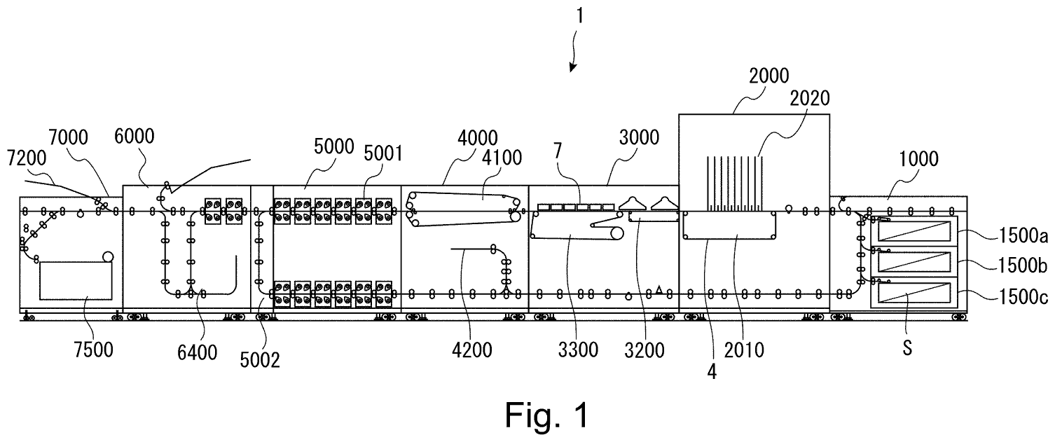

In the following, a first embodiment of the present invention will be described with reference to from FIG. 1 through FIG. 15. First, a schematic configuration of an image forming system according to the embodiment will be described by using FIG. 1.

### [Image Forming System]

An image forming system 1 as an image forming apparatus according to the embodiment applies an inkjet recording method which forms an image on a sheet by ejecting ink, and is a so-called sheet-fed type inkjet recording apparatus which forms an ink image on a sheet by using two liquids which are reaction liquid and ink. The sheet may be any recording material as far as ink is acceptable, for example, paper such as plain paper and cardboard, plastic film such as an overhead projector sheet, a specially shaped sheet such as an envelope and an index sheet, cloth, etc.

As shown in FIG. 1, the image forming system 1 according to the embodiment is provided with a feeding module 1000, a printing module 2000, a drying module 3000, a fixing module 4000, a cooling module 5000, a reversing module 6000, and a stacking module 7000. A sheet S which is supplied from the feeding module 1000 is processed in various steps while it is conveyed through each module along a conveying passage, and is finally discharged to the stacking module 7000.

Incidentally, each of the feeding module 1000, the printing module 2000, the drying module 3000, the fixing module 4000, the cooling module 5000, the reversing module 6000 and the stacking module 7000 may include a casing separately, and the image forming system 1 may be configured by connecting these casings. Alternatively, the feeding module 1000, the printing module 2000, the drying module 3000, the fixing module 4000, the cooling module 5000, the reversing module 6000, and the stacking module 7000 may be disposed in one casing.

The feeding module 1000 includes accommodating containers 1500a, 1500b, and 1500c which accommodate the sheet S, the accommodating containers from 1500a through 1500c are provided so that it is possible to be pulled out toward a front side of the apparatus. The sheet S is fed one sheet by one sheet by a separating belt and a conveying roller in each of the accommodating containers from 1500a through 1500c, and conveyed to the printing module 2000. Incidentally, the accommodating containers from 1500a through 1500c are not limited to be three, however, it may have one, two or four or more.

The printing module 2000 as an image forming portion includes a pre image forming registration correction portion (not shown), a print belt unit 2010 and a recording portion 2020. The sheet S which is conveyed from the feeding module 1000 is conveyed to the print belt unit 2010 after its inclination and position are corrected by the pre image forming registration correction portion. With respect to the conveying passage, the recording portion 2020 is disposed at a position opposing the print belt unit 2010. The recording portion 2020 is an inkjet recording portion which forms an image by ejecting ink onto the sheet S with a recording head from above onto the sheet S which is being conveyed. A plurality of recording heads which eject ink are arranged in a line along the conveying direction. In the embodiment, a total of five line type recording heads which corresponds to the reaction liquid in addition to four colors Y (yellow), M (magenta), C (cyan) and Bk (black), as well as are included. Since the sheet S is attracted and conveyed by the print belt unit 2010, clearance with the recording head is ensured.

Incidentally, the number of colors of ink and the number of recording heads are not limited to five which is described above. For an inkjet system, a system which uses a heat generating element, a system which uses a piezoelectric element, a system which uses an electrostatic element, and a system which uses a MEMS (Micro Electro Mechanical Systems) element, etc. may be applied. Ink of each color is supplied from an unshown ink tank to the recording head through ink tube, respectively. The ink includes “from 0.1 mass % to 20.0 mass %” based on a total ink mass of resin component, water and water soluble organic solvent, color material, wax, additives, etc.

When the sheet S on which an image is formed by the recording portion 2020 is conveyed by the print belt unit 2010, an inline scanner (not shown), which is disposed on a downstream side of the recording portion 2020 with respect to the conveying direction of the sheet S, detects misalignment and color density of the image which is formed on the sheet S. Based on the misalignment and the color density of the image, the image which is formed on the sheet S, the density, etc. are corrected.

The drying module 3000 includes a decoupling portion 3200, a drying belt unit 3300 and a warm air blowing unit 7. The drying module 3000 reduces liquid content of the ink and the reaction fluid which are applied to the sheet S in order to improve fixation property of the ink on the sheet S by the subsequent fixing module 4000. The sheet S on which the image is formed is conveyed to the decoupling portion 3200 which is disposed in the drying module 3000. In the decoupling portion 3200, frictional force is generated between the sheet S and the belt by wind pressure which is blown from above and the sheet S is conveyed by a belt. In this way, since the sheet S which is placed on the belt is conveyed by the frictional force, misalignment of the sheet S when it is conveyed across the print belt unit 2010 and the decoupling portion 3200 is prevented. The sheet S which is conveyed from the decoupling portion 3200 is attracted and conveyed by the drying belt unit 3300, and the ink and the reaction liquid which are applied to the sheet S are dried when warm air is blown from the warm air blowing unit 7 which is disposed above the belt.

In this way, since the drying module 3000 heats the ink and the reaction liquid which are applied to the sheet S and evaporation of moisture is promoted, it is possible to suppress generating so-called cockling which forms lines around the ink like fringe when the ink splashes onto the sheet S. Incidentally, the drying module 3000 may use any device which is able to heat and dry, however, for example, a warm air dryer or a heater is preferable. As a heater, for example, heating with an electric heating wire or an infrared heater, is preferable in terms of safety and energy efficiency.

The fixing module 4000 as a fixing system includes a fixing belt unit 4100 as a fixing device. The fixing belt unit 4100 fixes ink on the sheet S by passing the sheet S, which has been conveyed from the drying module 3000, between an upper belt unit and a lower belt unit which are heated. The fixing belt unit 4100 will be described in detail below.

The cooling module 5000 includes a plurality of cooling portions 5001, and the cooling portions 5001 cool the sheet S at high temperature which is conveyed from the fixing module 4000. The cooling portions 5001 cool the sheet S, for example, by increasing pressure in the cooling box when taking outside air into a cooling box with a fan and applying air which is blown from the cooling box through nozzles due to the pressure to the sheet S. The cooling portions 5001 are disposed on both sides of the conveying passage of the sheet S and cool both sides of the sheet S.

The cooling module 5000 is provided with a conveying passage switching portion 5002. The conveying passage switching portion 5002 switches conveying passages of the sheet S according to a case that the sheet S is conveyed to the reversing module 6000 or a case that the sheet S is conveyed to a duplex (double-side) conveying passage for duplex printing in which image forming is performed on both sides of the sheet S.

The reversing module 6000 includes a reversing portion 6400. The reversing portion 6400 reverses front and back of the sheet S which is being conveyed and changes a front and back direction of the sheet S when it is discharged to the stacking module 7000. The stacking module 7000 includes a top tray 7200 and a stacking portion 7500, and stacks the sheets S which is conveyed from the reversing module 6000.

During duplex printing, the sheet S is conveyed to the conveying passage below the cooling module 5000 by the conveying passage switching portion 5002. After that the sheet S is returned to the printing module 2000 through the duplex conveying passage of the fixing module 4000, the drying module 3000, the printing module 2000 and the feeding module 1000. A duplex conveying portion of the fixing module 4000 is provided with a reversing portion 4200 which reverses front and back of the sheet S. The sheet S has been returned to the printing module 2000, an image is formed on the other surface of the sheet S on which the image is not formed, and the sheet S is discharged to the stacking module 7000 through the drying module 3000, the fixing module 4000, the cooling module 5000 and the reversing module 6000.

### [Drying Module]

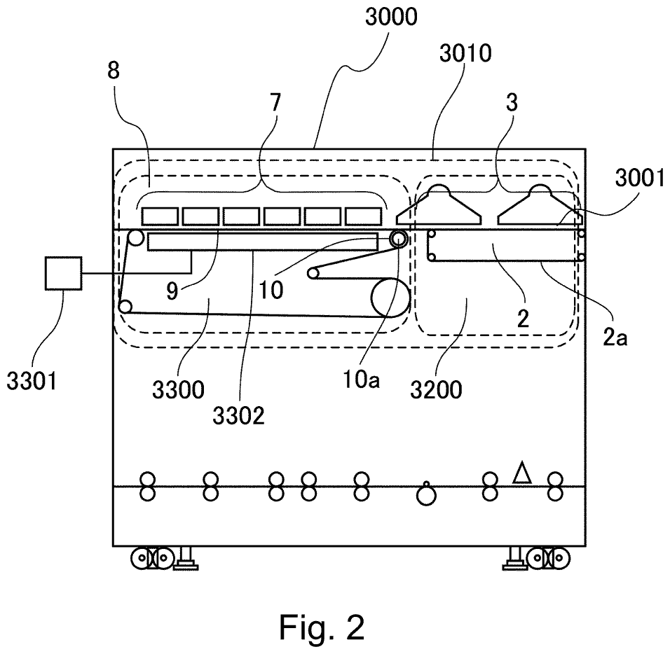

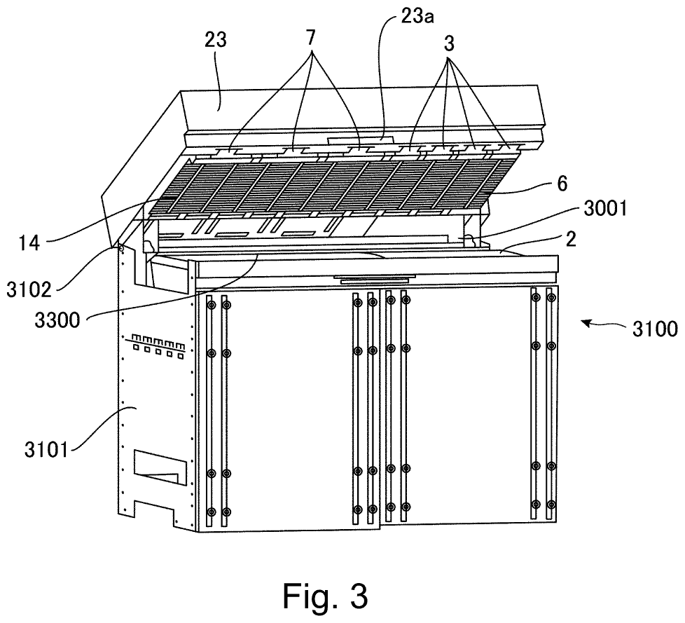

Next, the drying module 3000 will be described in detail by using FIG. 2 and FIG. 3. As described above, the drying module 3000 includes the decoupling portion 3200, the drying belt unit 3300 and the warm air blowing unit 7. These are collectively referred to as a drying function portion 3010. The drying function portion 3010 is disposed in an upper part of the drying module 3000 and includes a straight sheet conveying passage 3001 to receive the sheet S which is discharged from the printing module 2000, dry the sheet S, and then deliver the sheet S to the fixing module 4000. With respect to a sheet conveying direction in the sheet conveying passage 3001, functions are different between an upstream portion and a downstream portion of the drying function portion 3010.

In the upstream portion of the drying function portion 3010, the decoupling portion 3200 as an air blowing device is disposed. The decoupling portion 3200 includes a decoupling belt unit 2 as a sheet conveyance portion and a cold air blowing unit 3 as an air blowing portion. The cold air blowing unit 3 is disposed above the decoupling belt unit 2 with respect to a vertical direction, and the decoupling belt unit 2 conveys the sheet S in a substantially horizontal direction. The decoupling belt unit 2 includes an endless belt 2a which is rotatable. And the sheet S is conveyed while the sheet S is pressed toward the belt 2a by blowing cold air (air) from an upper side of the decoupling belt unit 2 by the cold air blowing unit 3. Incidentally, air which has not been heated by a heater, etc. is also referred to as “cold air” in the following.

When a leading end of the sheet S reaches the decoupling belt unit 2 of the drying module 3000, a trailing end of the sheet S is still on the print belt unit 2010 of the printing module 2000. The print belt unit 2010 includes an endless print belt 4 (FIG. 1) which sucks and conveys the sheet S. On the print belt 4, image forming is performed on the sheet S, and the sheet S is sucked and conveyed on the print belt 4. To avoid any disturbance to the image forming process, force which presses the sheet S against the belt 2a is weaker than force which sucks the print belt 4, and the belt 2a is driven at a slightly faster speed than the print belt 4. That is, the sheet S always slides on the belt 2a while the trailing end of the sheet S is on the print belt 4.

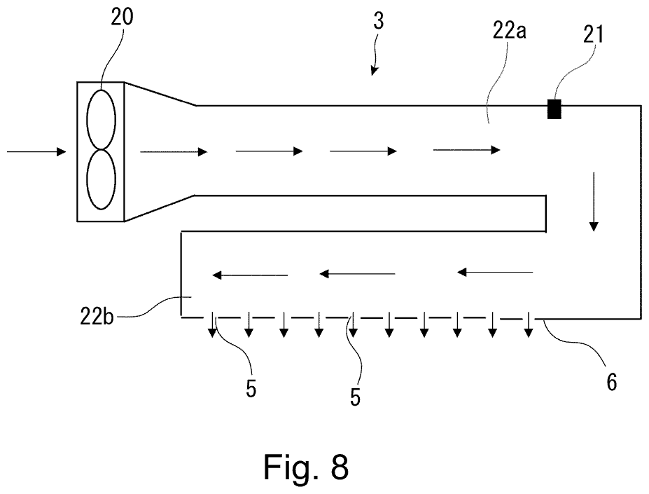

On the other hand, as soon as the trailing end of the sheet S leaves a region of the print belt 4, conveyance of the sheet S becomes dependent on the belt 2a. At this time, it is necessary to control air blowing force of the cold air blowing unit 3 so that the sheet S does not slide against conveyance resistance. So, as will be described in detail by using FIG. 8 which will be described below, velocity of air which is blown from the cold air blowing unit 3 onto the sheet S which is conveyed on the belt 2a is controlled to a predetermined pressure by using a pressure sensor 21 which is provided inside the cold air blowing unit 3 and an intake fan 20 which is provided with an air intake portion. The cold air blowing unit 3 includes a cold air blowing surface 6 with which a number of cold air blowing holes 5 for air to pass through are provided so that it is possible to apply uniform pressing force to the sheet S.

In the downstream portion of the drying function portion 3010, a drying portion 8 as a drying device is disposed. The drying portion 8 includes the drying belt unit 3300 as a sheet conveyance portion and the warm air blowing unit 7 as the warm air blowing portion. The warm air blowing unit 7 is disposed above the drying belt unit 3300 with respect to the vertical direction, and the drying belt unit 3300 conveys the sheet S in the substantially horizontal direction.

The drying belt unit 3300 includes a drying belt 9 which is rotatable and endless, a plurality of stretching rollers 10 which stretch the drying belt 9, and a heater 10a as a belt heater which heats the drying belt 9, and conveys a sheet while heating the sheet with the drying belt 9. The heater 10a is a halogen heater which is disposed inside any stretching roller 10 of the plurality of stretching rollers 10 and heats the drying belt 9 via the stretching roller 10. In the embodiment, among pairs of stretching rollers 10 which stretch a surface opposing the warm air blowing unit 7, the heater 10a is disposed inside the stretching roller 10 in an upstream side with respect to the sheet conveying direction. Further, the drying belt unit 3300 includes a suction fan 3301 as a suction portion which sucks air.

The drying belt 9 includes a plurality of suction holes (not shown) through which air is sucked by the suction fan 3301. Further, a suction box (chamber) 3302 which is connected to the suction fan 3301 is disposed inside the surface of the drying belt 9 opposing the warm air blowing unit 7 (that is, a side on which the sheet is conveyed). A suction opening is formed on a surface of the suction box 3302 opposing the drying belt 9. And a configuration is such that the sheet is attracted to the surface of the drying belt 9 when the suction fan 3301 sucks air through the suction box 3302 and air is sucked through the plurality of suction holes of the drying belt 9. Such the drying belt unit 3300 is capable of attracting the sheet to the surface of the drying belt 9 and conveying the sheet.

Furthermore, in the drying portion 8, while the sheet S is attracted onto the drying belt 9 by sucking the sheet S with the drying belt unit 3300, the sheet S is dried when warm air is blown from an upper side in the vertical direction by the warm air blowing unit 7, and the sheet S is conveyed while suppressing waving which is called cockling. In order to dry the sheet S rapidly, surface temperature of the drying belt 9 is adjusted to a predetermined temperature by controlling the heater 10a which is disposed inside the stretching roller 10 based on temperature which is detected by a temperature sensor (not shown) which is provided inside the drying belt unit 3300. In this way, the sheet S which is conveyed by the drying belt 9 is heated.

On the other hand, as will be described in detail in FIG. 5 which will be described below, a warm air temperature inside the warm air blowing unit 7 is controlled at a predetermined temperature by using a temperature sensor 11 and a sheathed heater 12 which are provided inside the unit. Further, velocity of air which is blown from warm air blowing holes 13 of the warm air blowing unit 7 is controlled to a predetermined pressure by using a pressure sensor 14 which is provided inside the unit and an air intake fan 15 which is provided with an air intake portion. The warm air blowing unit 7 dries the ink on the sheet S by such a configuration.

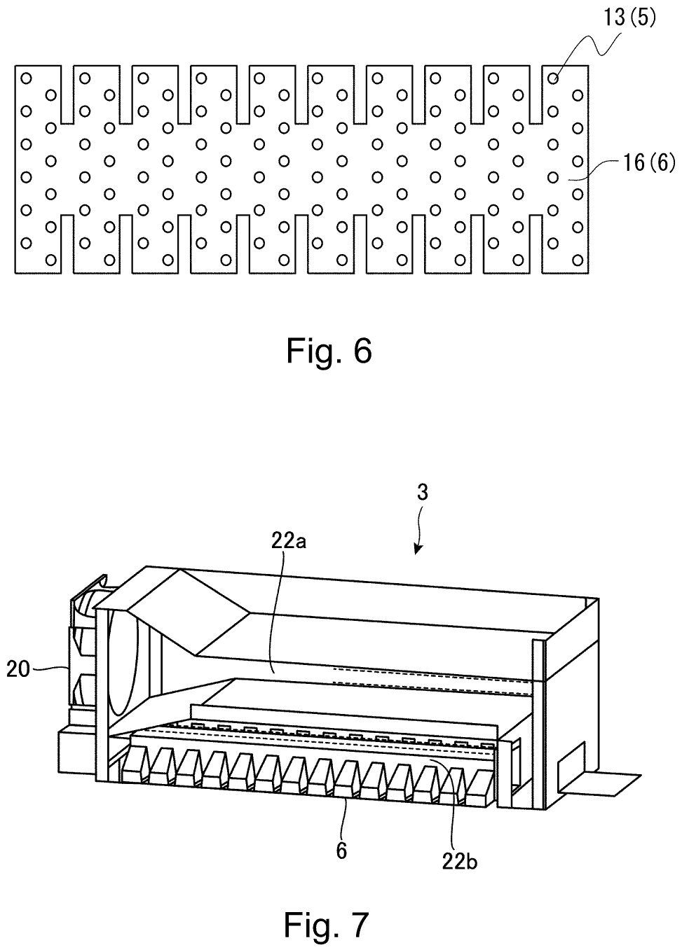

The warm air blowing unit 7 includes a warm air blowing surface 16 which is provided with the numerous warm air blowing holes 13 which pass through air so that it is possible to dry the sheet S uniformly (see FIG. 5 and FIG. 6). In order to fix the sheet S on the drying belt 9, suction pressure on a top surface of the drying belt 9 is adjusted to a predetermined pressure by controlling the suction fan 3301 which is provided with the suction portion based on pressure which is detected by a pressure sensor (not shown) which is provided inside the suction box 3302. In this way, the warm air blowing unit 7 presses the sheet S onto the drying belt 9 by blowing warm air. Incidentally, a distance from a suction end position of the print belt 4 to a suction start position of the drying belt 9 is set to be longer than a maximum sheet length.

### [Main Body Portion of the Drying Module]

The decoupling portion 3200, the drying belt unit 3300 and the warm air blowing unit 7 which are described above are disposed inside the main body portion 3100 of the drying module 3000. The main body portion 3100 includes an upper door (upper side casing) 23 as a casing and a first casing and a lower side casing 3101 as a second casing, as shown in FIG. 3. The warm air blowing unit 7 and the cold air blowing unit 3 are accommodated inside the upper door 23. Further, the drying belt unit 3300 and the decoupling belt unit 2 are accommodated inside the lower side casing 3101. The upper door 23 is configured to open upward to the lower side casing 3101.

That is, the main body portion 3100 is provided with a supporting portion 3102 which rotatably supports the upper door 23 with respect to the lower side casing 3101. The upper door 23 is rotatable around the supporting portion 3102 between a closed position in which the warm air blowing unit 7 and the cold air blowing unit 3 oppose the drying belt unit 3300 and the decoupling belt unit 2, and an open position in which the warm air blowing unit 7 and the cold air blowing unit 3 are spaced away from the drying belt unit 3300 and the decoupling belt unit 2 and the warm air blowing unit 7 and the cold air blowing unit 3 are exposed.

The supporting portion 3102 is disposed on a back side of the apparatus and includes a rotational center shaft which is substantially parallel to the sheet conveying direction. A handle portion 23a is provided with the upper door 23 on a front side of the apparatus, so it is possible to lift it up when a user, etc. puts his or her hand on the handle portion 23a. Therefore, when a user, etc. puts his or her hand on the handle portion 23a and lifts up the upper door 23 from the front side of the apparatus, the upper door 23 rotates around the rotational center axis of the supporting portion 3102 and the upper door 23 is in the open position. When a user, etc. pushes down the upper door 23 from the open position, the upper door 23 rotates around the rotational center axis of the supporting portion 3102 and the upper door 23 is in the closed position.

By setting the upper door 23 to the open position, the sheet conveying passage 3001 between the warm air blowing unit 7 and the cold air blowing unit 3 and the drying belt unit 3300 and the decoupling belt unit 2 is opened. In this way, when a jam occurs in which a sheet S is jammed in the sheet conveying passage 3001 while an image forming job is being executed, it is possible to perform jam processing to remove the sheet which is jammed in the sheet conveying passage 3001 by opening the upper door 23. Further, in a state that the upper door 23 is open, the warm air blowing unit 7 and the cold air blowing unit 3 are exposed, so a user, etc. is able to perform maintenance such as replacing them. In the embodiment, the warm air blowing unit 7 and the cold air blowing unit 3 are configured to be dismountable from the upper door 23. In the following, each of these units will be described in detail.

### [Warm Air Blowing Unit]

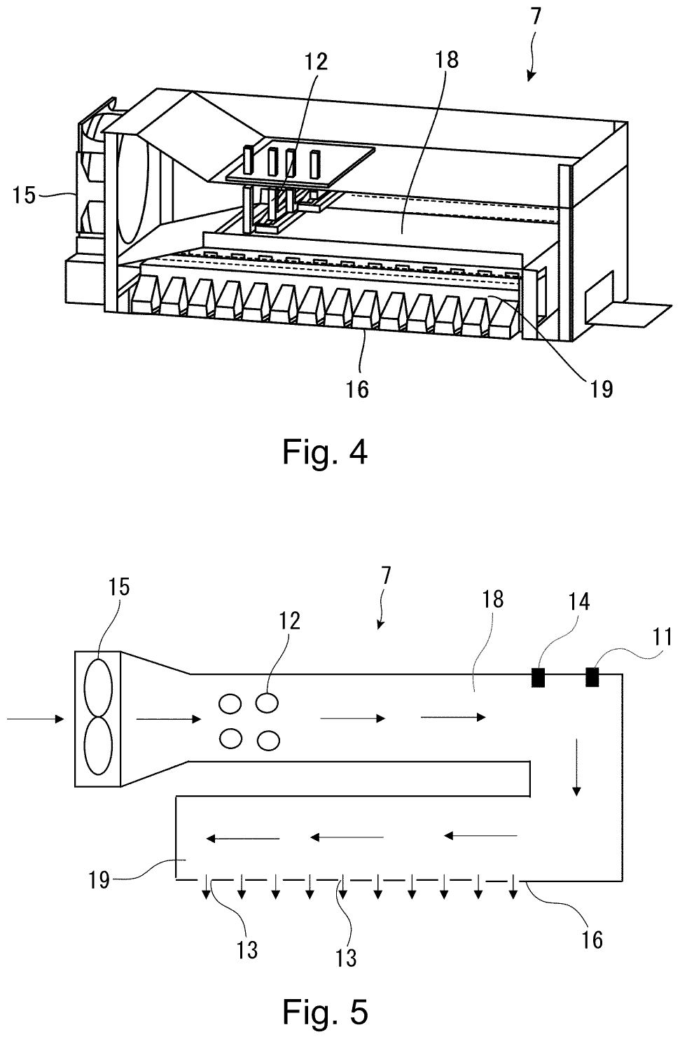

First of all, the warm air blowing unit 7 will be described by using from FIG. 4 through FIG. 6. FIG. 4 is the perspective view showing the warm air blowing unit 7, when a side surface of the warm air blowing unit 7 is cut. FIG. 5 is the sectional view of the schematic configuration of the warm air blowing unit 7, schematically showing an air flow from the intake fan 15 to the warm air blowing holes 13. FIG. 6 shows a plan view of the warm air blowing surface 16 of the warm air blowing unit 7, when it is viewed from below. Incidentally, a configuration of the cold air blowing surface 6 of the cold air blowing unit 3, which will be described below, is the same as that of the warm air blowing surface 16, so reference numerals are shown in brackets in FIG. 6.

As shown in FIG. 4 and FIG. 5, the warm air blowing unit 7 includes the intake fan 15 as an air blowing portion, a first passage portion 18 and a second passage portion 19 as passage portions, the sheathed heater 12 as a heating portion, the temperature sensor 11 as a temperature detecting portion, the pressure sensor 14 as a pressure detecting portion and the warm air blowing surface 16 as a blowing portion.

The intake fan 15 sucks air from outside and blows it to the first passage portion 18 and the second passage portion 19. The first passage portion 18 and the second passage portion 19 are passages through which the air blown from the intake fan 15 is flowing. The sheathed heater 12 heats the air which is flowing through the first passage portion 18 and the second passage portion 19. The temperature sensor 11 detects temperature of the air which is flowing through the first passage portion 18 and the second passage portion 19. The pressure sensor 14 detects pressure of the air which is flowing through the first passage portion 18 and the second passage portion 19. The warm air blowing surface 16 includes the plurality of warm air blowing holes 13, as shown in FIG. 6, and blows the air, which flows through the first passage portion 18 and the second passage portion 19 and is heated by the sheathed heater 12, toward the drying belt unit 3300.

In the embodiment, the passage portion through which the air is flowing is divided into the first passage portion 18 and the second passage portion 19. In the first passage portion 18, the sheathed heater 12 is disposed, and the air which is flowing through the first passage portion 18 is heated by the sheathed heater 12. The second passage portion (chamber) 19 is disposed on a downstream side of the first passage portion 18 with respect to a direction of the air flowing, and the warm air blowing surface 16 is disposed in the second passage portion 19. The air which is heated by the sheathed heater 12 in the first passage portion 18 reaches the second passage portion 19 and is blown from the warm air blowing holes 13 of the warm air blowing surface 16 toward the sheet which is conveyed by the drying belt 9 of the drying belt unit 3300. The warm air blowing unit 7 is a closed and continuous passage so that the air does not leak throughout the first passage portion 18 and the second passage portion 19, except for the intake fan 15 (input) and the warm air blowing holes 13 (output).

In a case of the embodiment, the warm air blowing unit 7 is dismountable from the upper door 23, while the intake fan 15, the first passage portion 18, the second passage portion 19, the sheathed heater 12, the temperature sensor 11, the pressure sensor 14 and the warm air blowing surface 16 are integrated as a single unit. This is a configuration which is possible to conduct function tests on unit by unit basis at a time of factory shipment of the warm air blowing unit 7, and a configuration which is possible to supply to markets as a unit in which its function is guaranteed. Incidentally, the pressure sensor 14 may be omitted.

### [Cold Air Blowing Unit]

Next, the cold air blowing unit 3 will be described by using FIG. 7 and FIG. 8. FIG. 7 is the perspective view showing the cold air blowing unit 3, when a side surface of the cold air blowing unit 3 is cut. FIG. 8 is the sectional view of the schematic configuration of the cold air blowing unit 3, schematically showing an air flow from the intake fan 20 to the cold air blowing holes 5. The cold air blowing unit 3 includes the intake fan 20 as an air blowing portion, a first passage portion 22a and a second passage portion 22b as passage portions, the pressure sensor 21 as a pressure detecting portion and the cold air blowing surface 6 as a blowing portion.

The intake fan 20 sucks air from outside and blows it to the first passage portion 22a and the second passage portion 22b. The first passage portion 22a and the second passage portion 22b are passages through which the air blown from the intake fan 20 is flowing. The pressure sensor 21 detects pressure of the air which is flowing through the first passage portion 22a and the second passage portion 22b. The cold air blowing surface 6 includes the plurality of cold air blowing holes 5 and blows the air, which flows through the first passage portion 22a and the second passage portion 22b, toward the decoupling belt unit 2.

In the embodiment, the passage portion through which the air is flowing is divided into the first passage portion 22a and the second passage portion 22b, and the second passage portion (chamber) 22b is disposed on a downstream side of the first passage portion 22a with respect to a direction of the air flowing and the cold air blowing surface 6 is disposed. The air which is supplied from the intake fan 20 into the first passage portion 22a reaches the second passage portion 22b and is blown through the cold air blowing holes 5 of the cold air blowing surface 6 toward the sheet which is conveyed by the belt 2a of the decoupling belt unit 2. The cold air blowing unit 3 is a closed and continuous passage so that the air does not leak throughout the first passage portion 22a and the second passage portion 22b, except for the intake fan 20 (input) and the cold air blowing holes 5 (output).

In a case of the embodiment, the cold air blowing unit 3 is dismountable from the upper door 23, while the intake fan 20, the first passage portion 22a, the second passage portion 22b, the pressure sensor 21 and the cold air blowing surface 6 are integrated as a single unit. This is a configuration which is possible to conduct function tests on unit by unit basis at a time of factory shipment of the cold air blowing unit 3, and a configuration which is possible to supply to markets as a unit in which its function is guaranteed.

### [Replaceability of the Warm Air Blowing Unit]

As described above, in order to ensure ease of maintenance during jam processing, etc., the warm air blowing unit 7 and the cold air blowing unit 3 are configured to accommodate a part which includes these units in the upper door 23 which opens upwards. The upper door 23 is desired to be as small as possible for ease of operation such as opening and closing, and workability of replacing the air blowing unit, etc. in markets tends to be reduced. For example, works such as removing all of exterior covers and interior covers of the upper door 23, accessing it from a top portion and removing the upper door 23 itself from the main body portion 3100 are considered, however, these may be a burden on a service in the market as work at a high place and heavy load work and, furthermore, risk of secondary failure to the apparatus due to a work mistake may be increased.

Further, due to space limitations, functional components are dispersed and disposed in the main body portion 3100, and even in a case of replacing the components, each of the components tends to be in a configuration in which it is mounted and dismounted as a single component, however, from a point of view of guaranteeing functionality after replacement, it is desirable to replace them in a unit which is guaranteed at factory shipment. Therefore, a replacement unit is required to include the components which are involved in their functional expression in the unit. In response to the above issues, in the embodiment, a configuration which prevents declines in operational efficiency of the products and suppresses impacts on customers' business to a minimum is provided by reducing burdens on markets during service replacement, ensuring safety of service persons and reducing risks of secondary damage to product functions due to operational errors.

The warm air blowing unit 7 is provided with devices such as the fan, the heater and the sensor, as described above, and these components are known to have a certain failure rate over product lifetime. Therefore, the configuration, which is capable of being replaced in the markets in the event of a failure, is required. In the commercial printing market, since the operational efficiency of the products is the most important for customers, so replacing operation should be carried out quickly, and furthermore, it is desired that rework due to work mistake, poor unit quality, etc. may be prevented.

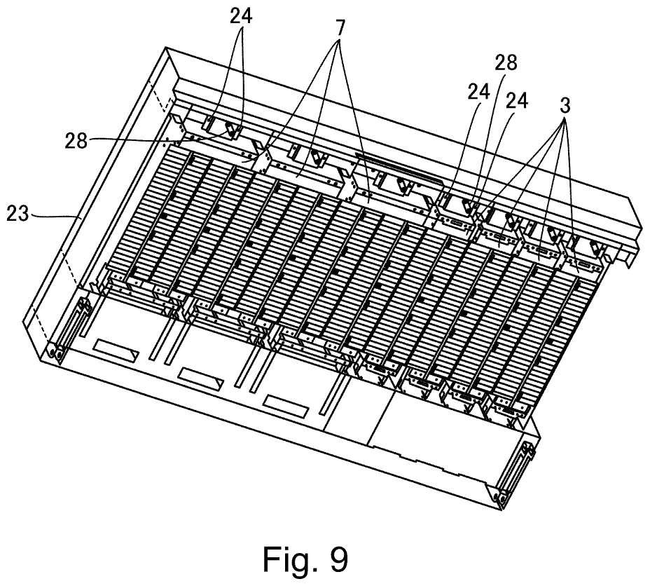

In order to satisfy these requirements, in the embodiment, in a unit of the warm air blowing unit 7 with which all the necessary elements for functionality are provided and in which functionality is guaranteed, it is configured so that it is dismountable from the main body portion 3100 of the drying module 3000, and furthermore its replaceability is improved. As described in FIG. 3 above, in the main body portion 3100, the upper door 23 is rotatably supported with respect to the lower casing 3101, and the warm air blowing unit 7 and the cold air blowing unit 3 are dismountably accommodated in the upper door 23. And by opening the upper door 23, the warm air blowing unit 7 and the cold air blowing unit 3 are exposed and these are replaceable. In the following, a configuration, which is related to replacement of the warm air blowing unit 7, will be described by using from FIG. 9 through FIG. 11.

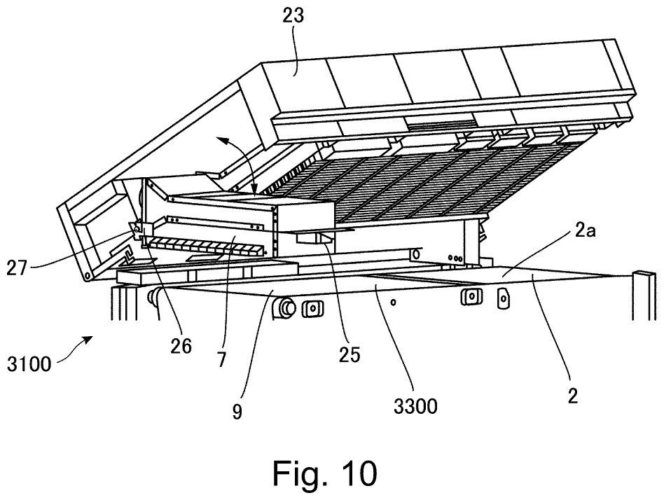

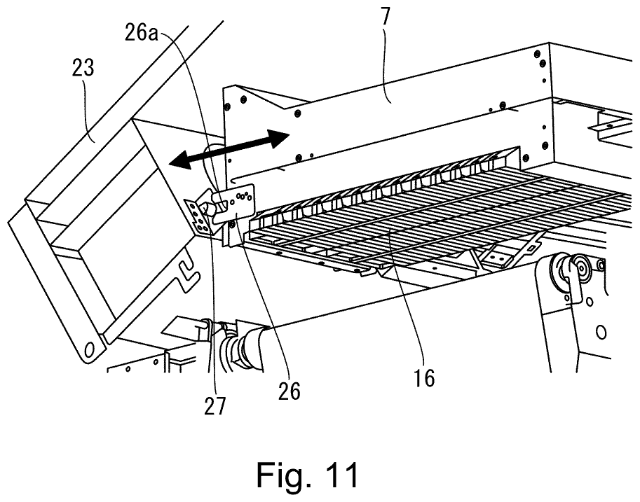

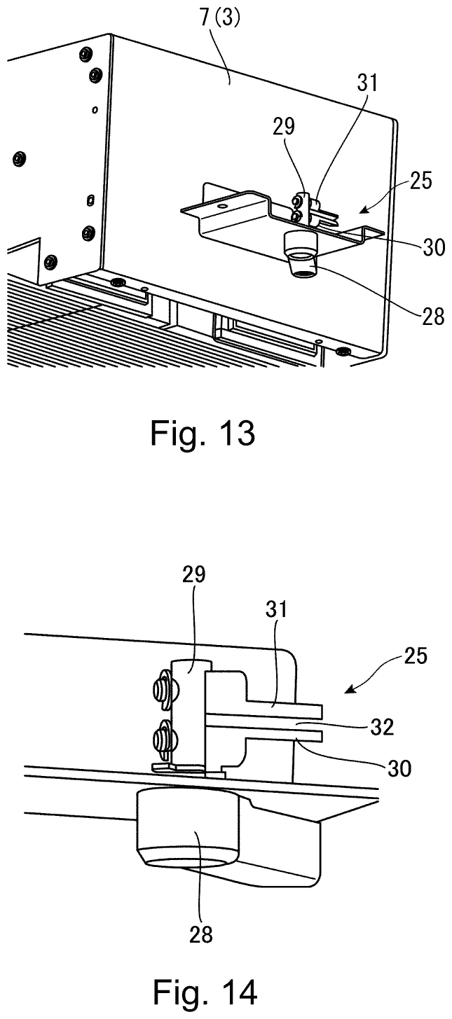

FIG. 9 is a view of the upper door 23 when it is seen from the sheet conveying passage 3001. FIG. 10 is the perspective view showing the state that the warm air blowing unit 7 is mounted on and dismounted from the upper door 23 when a part of the upper door 23 is cut, and FIG. 11 is the enlarged perspective view showing a configuration of mounting and dismounting in a back side of the apparatus of the warm air blowing unit 7. The upper door 23 includes a positioning pin 27 as a one end side holding portion and a positioning plate 33 (part (a) and part (b) of FIG. 15) as the other end side holding portion. On the other hand, the warm air blowing unit 7 includes an engaging plate 26 as an engaging portion, a locking member 30 and a locking member 31 (from FIG. 13 through part (b) of FIG. 15) as locking portions and a locking lever 28 as an operating portion.

The positioning pin 27 is provided near an end portion of one end side of the upper door 23 in a predetermined direction and rotatably holds one end portion of the warm air blowing unit 7 in the predetermined direction with respect to the upper door 23. The predetermined direction is a direction from the front side toward the back side of the apparatus, and the one end side portion is an end portion of the back side of the apparatus. The engaging plate 26 is provided on the one end portion (the end portion of the back side of the apparatus) of the warm air blowing unit 7, and a notch 26a which is able to engage with the positioning pin 27 is formed in the engaging plate 26. And when the positioning pin 27 enters and engages the notch 26a of the engaging plate 26, the end portion of the back side of the warm air blowing unit 7 is rotatably held with respect to the positioning pin 27 (see FIG. 10 and FIG. 11).

Specifically, the warm air blowing unit 7 is rotatably held between a first position (a position which is shown in FIG. 9) in which the other end portion (the end portion of the front side of the apparatus) of the warm air blowing unit 7 in the predetermined direction with respect to the upper door 23 is accommodated inside the upper door 23, and a second position (a position which is shown in FIG. 10) in which the end portion of the front side of the apparatus is exposed to an outside of the upper door 23 more than in the first position.

The positioning pin 27 is a rotational shaft which rotationally supports the end portion of the back side of the warm air blowing unit 7. On the other hand, the engaging plate 26 is dismountable from the positioning pin 27 in a state that the end portion of the front side of the warm air blowing unit 7 is located in the second position, and is rotatably engaged with the positioning pin 27 in a state that the end portion of the front side of the warm air blowing unit 7 is located in the first position. Therefore, the notch 26a is open toward a back side of the engaging plate 26, and the notch 26a and the positioning pin 27 are engaged when the positioning pin 27 enters through the opening, and the warm air blowing unit 7 is rotatable around the engaging portion.

A center axis of the positioning pin 27 is substantially parallel to a rotational center axis of the supporting portion 3102 which rotationally supports the upper door 23, and the warm air blowing unit 7 rotates around the center axis while the positioning pin 27 and the engaging plate 26 are engaged. On the other hand, when the warm air blowing unit 7 is dismounted from the upper door 23, by moving the warm air blowing unit 7 toward the front side of the apparatus, the positioning pin 27 is come out of the notch 26a and the engagement between the positioning pin 27 and the engaging plate 26 is released.

The positioning plate 33 is able to hold the end portion of the front side of the warm air blowing unit 7 to the upper door 23 in a state that the other end portion (the end portion of the front side of the apparatus) of the warm air blowing unit 7 is in the first position. As shown in from FIG. 13 through part (b) of FIG. 15 which will be described below, the locking member 30, the locking member 31 and the locking lever 28 are provided on the end portion of the front side of the warm air blowing unit 7, and the locking member 30 and the locking member 31 are rotatable around a rotational shaft 29 with the locking lever 28.

As shown in part (a) of FIG. 15, a through hole 33a through which the locking member 30 and the locking member 31 can pass is formed on the positioning plate 33, and when the locking member 30 and the locking member 31 are engaged with an engaging surface 33b which is away from the through hole 33a of the positioning plate 33, the end portion of the front side of the warm air blowing unit 7 is positioned on the positioning plate 33, and the warm air blowing unit 7 is held in the first position. Further, in a state that the warm air blowing unit 7 is held in the first position, the end portion of the front side of the warm air blowing unit 7 is fixed to the upper door 23 by a fixing screw 24, as shown in FIG. 9. A locking mechanism 25, which includes the locking member 30, the locking member 31, etc., will be described in detail below.

In a case of removing the warm air blowing unit 7 from the upper door 23, first of all, the fixing screw 24 on the front side is removed. At this time, a connector (not shown), which is electrically connected between the upper door 23 side near the fixing screw 24 and the warm air blowing unit 7, is also removed. After that, by rotating the locking lever 28 while supporting the front side of the warm air blowing unit 7 by hand, the warm air blowing unit 7 and the upper door 23 are unlocked, and the warm air blowing unit 7 will try to move vertically downwards by its own weight.

At this time, since in the end portion of the back side of the warm air blowing unit 7, as shown in FIG. 10, the engaging plate 26 is engaged with the positioning pin 27, the warm air blowing unit 7 rotates so that the front side of the warm air blowing unit 7 moves downwards from the upper door 23 with the engaging portion as a center of rotation. Next, after lowering the warm air blowing unit 7 to a position in which it is substantially horizontal, by pulling the warm air blowing unit 7 toward the front side of the apparatus as shown in FIG. 11, the engaging plate 26 is removed from the positioning pin 27 and it is possible to remove the warm air blowing unit 7 from the upper door 23. In a case that the warm air blowing unit 7 is mounted on the upper door 23, the process which is described above may be followed in reverse.

### [Replaceability of the Cold Air Blowing Unit]

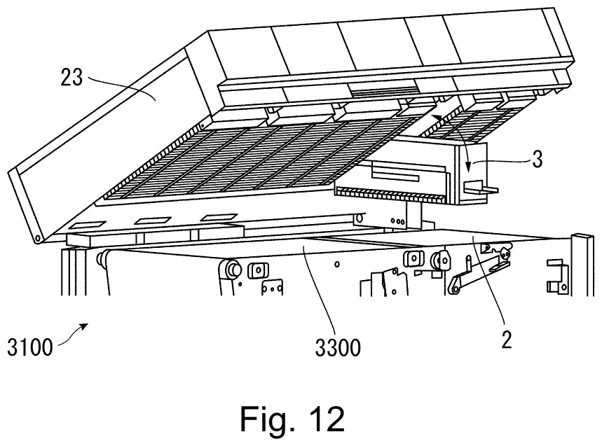

Next, a configuration, which is related to replacement of the cold air blowing unit 3, will be described by using FIG. 12, while referring from FIG. 9 through FIG. 11. Similar to the warm air blowing unit 7, the cold air blowing unit 3 is also provided with all the necessary elements for functionality and is configured so that it is dismountable from the main body portion 3100 of the drying module 3000 in a unit of the cold air blowing unit 3 in which its functionality is guaranteed and furthermore its replaceability is improved. Mounting configuration and replacing operation of the upper door 23 and the cold air blowing unit 3 are similar to that of the warm air blowing unit 7.

Therefore, similar to the warm air blowing unit 7, the cold air blowing unit 3 also includes the engaging plate 26 as the engaging portion, the locking member 30 and the locking member 31 (from FIG. 13 through part (b) of FIG. 15) as the locking portions and the locking lever 28 as the operating portion. Further, the upper door 23 also includes the positioning pin 27 as the one end side holding portion and the positioning plate 33 (part (a) and part (b) of FIG. 15) as the other end side holding portion, in order to mount on and dismount from the cold air blowing unit 3. In a case of the cold air blowing unit 3, the front side of the apparatus is also moved downward, and it is mounted on and dismounted from the upper door 23, as shown in FIG. 12.

### [Locking Mechanism]

Next, a configuration of the locking mechanism 25 will be described by using FIG. 13 through part (b) of FIG. 15. As the configurations of the locking mechanisms 25 of the warm air blowing unit 7 and the cold air blowing unit 3 are same, in the following, the locking mechanism 25 of the warm air blowing unit 7 will be described as a representative. As described above, the warm air blowing unit 7 includes the locking member 30 and the locking member 31 as the locking portions which are able to lock and unlock the positioning plate 33 on the end portion of the front side of the apparatus, and the locking lever 28 which is able to operate the locking member 30 and the locking member 31.

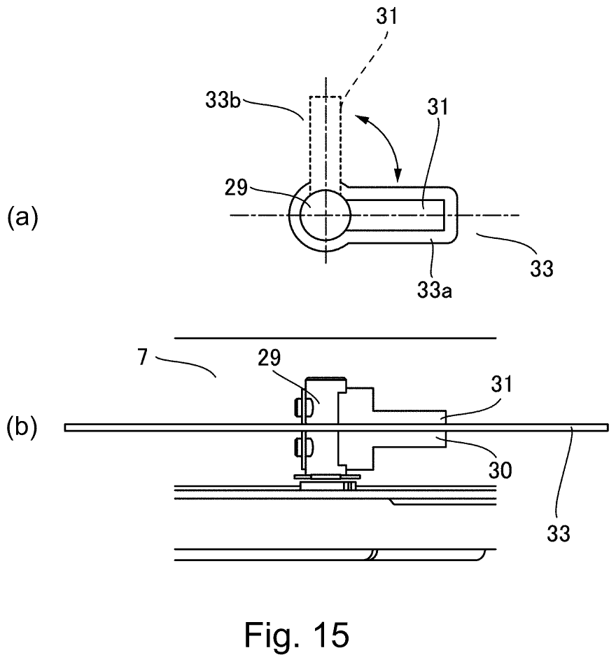

As shown in FIG. 13 and FIG. 14, the locking lever 28 is rotatably provided within a predetermined angle around the rotational shaft 29, and the locking member 30 and the locking member 31 are fixed to the rotational shaft 29 along an extension of the rotational shaft 29. The locking member 30 and the locking member 31 are provided so that they are spaced away in a direction along a center axis of the rotational shaft 29, and there is a predetermined gap 32 between the locking member 30 which is on a lower side in the figure and the locking member 31 which is on an upper side in the figure.

Accompanied with rotation of the locking lever 28, the rotational shaft 29 is able to rotate from a locked position to an unlocked position together with the locking member 30 and the locking member 31. On the other hand, as shown in part (a) of FIG. 15, the positioning plate (sheet metal) 33 on the upper door 23 side is provided with the through hole (locking hole) 33a into which the rotational shaft 29 is inserted, and the through hole 33a is shaped so that the locking member 31, which is on the upper side and at an unlocked angle, is passed through.

When mounting the warm air blowing unit 7 on the upper door 23, the end portion of the back side of the warm air blowing unit 7 is rotatably held by engaging the engaging plate 26 with the positioning pin 27 as described above. And the warm air blowing unit 7 is moved toward the first position by lifting the front side of the warm air blowing unit 7. When the warm air blowing unit 7 is moved to a position (the first position) in which it is fixed to the upper door 23, the locking member 31 on the upper side passes through the through hole 33a and, as shown in part (b) of FIG. 15, the locking member 31 on the upper side is positioned above the positioning plate 33 and the locking member 30 on the lower side is positioned below the positioning plate 33, while sandwiching the positioning plate 33 in which the through hole 33a is formed.

And in the position, when the locking lever 28 is rotated and the locking member 30 and the locking member 31 are rotated to the locked position, the positioning plate 33 enters the gap 32 of the locking member 30 and the locking member 31 and engages the locking member 31 on the upper side and the engaging surface 33b of the positioning plate 33, so the warm air blowing unit 7 is supported by its own weight. In this state, when the front side of the warm air blowing unit 7 is fixed to the upper door 23 by the fixing screw 24, mounting of the warm air blowing unit 7 on the upper door 23 is completed.

On the other hand, when the warm air blowing unit 7 is removed from the upper door 23, the fixing screw 24 is removed and the locking mechanism 25 is unlocked. At this time, the locking lever 28 is rotated and the locking member 30 and the locking member 31 are moved to a position in which they overlap the through hole 33a of the positioning plate 33. Then, since the front side of the warm air blowing unit 7 is able to move downward as the locking member 31 on the upper side passes through the through hole 33a, the warm air blowing unit 7 is in an attitude which is shown in FIG. 10 and FIG. 11 as described above. And the engaging plate 26 is released from the positioning pin 27 by pulling the warm air blowing unit 7 toward the front side in the attitude and it is possible to remove the warm air blowing unit 7 from the upper door 23. The locking mechanism 25 prevents the warm air blowing unit 7 from dropping abruptly downward after the fixing screw 24 is removed.

In a case of the embodiment, the warm air blowing unit 7 is dismountable from the upper door 23, as the intake fan 15, the first passage portion 18, the second passage portion 19, the sheathed heater 12, the temperature sensor 11, the pressure sensor 14 and the warm air blowing surface 16, which are a unit basis whose function is guaranteed, are as a whole. Further, the cold air blowing unit 3 is dismountable from the upper door 23, as the intake fan 20, the first passage portion 22a, the second passage portion 22b, the pressure sensor 21 and the cold air blowing surface 6, which are a unit basis whose function is guaranteed, are as a whole. Therefore, it is easier to guarantee functions after component replacement.

Further, the warm air blowing unit 7 and the cold air blowing unit 3 are configured so that the end portion of the back side of the apparatus is rotatably held with respect to the upper door 23 and the end portion of the front side of the apparatus is held by the upper door 23 while the units are accommodated in the upper door 23 (first state). Further, the end portion of the front side of the apparatus is configured so that it is possible to lock and unlock by the locking mechanism 25. Therefore, when the warm air blowing unit 7 and the cold air blowing unit 3 are removed, first of all, holding on the end portion of the front side of the warm air blowing unit 7 and the cold air blowing unit 3 is removed by unlocking the locking mechanism 25. Next, the warm air blowing unit 7 and the cold air blowing unit 3 are positioned at a position to be pulled to the front side of the apparatus by rotating the warm air blowing unit 7 and the cold air blowing unit 3 around the engaging portion of the back side of the apparatus. And by pulling out the warm air blowing unit 7 and the cold air blowing unit 3, engaging of the engaging portion of the back side of the apparatus is released, and it is possible to remove the warm air blowing unit 7 and the cold air blowing unit 3 from the upper door 23.

Therefore, when the warm air blowing unit 7 and the cold air blowing unit 3 are removed, it is possible to easily perform mounting and dismounting operations without performing operations such as removing a cover of the upper door 23. Further, when the warm air blowing unit 7 and the cold air blowing unit 3 are removed from the upper door 23 which opens upward, the operation may be performed in high places, however, as described above, since the apparatus is configured so that the front side of the warm air blowing unit 7 and the cold air blowing unit 3 is lowered downward and pulled out, the operation does not need to be performed in high places and safety of the operation is ensured. When the warm air blowing unit 7 and the cold air blowing unit 3 are mounted on the upper door 23, the procedure as described above may be reversed, and after all, the operation may be performed safely and easily.

As described above, in the embodiment, the warm air blowing unit 7 and the cold air blowing unit 3 are replaceable as the unit basis whose function is guaranteed, and it is possible to improve safety and easiness of the operations when they are mounted on and dismounted from, so it is possible to reduce service burden in the markets and suppresses impacts on customers' business to a minimum by replacing operation of the units.

### Second Embodiment

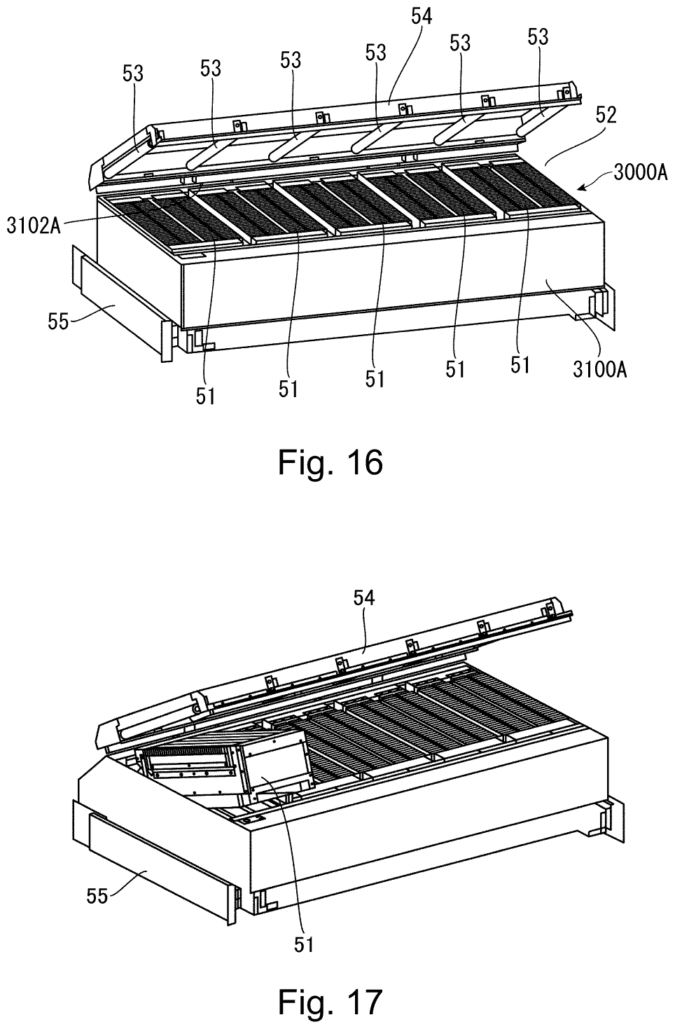

A second embodiment of the present invention will be described by using FIG. 16 and FIG. 17. In the first embodiment which is described above, the configuration in which the warm air blowing unit 7 is mounted on and dismounted from the upper door 23. On the other hand, in the embodiment, the warm air blowing unit 51 is configured to be mounted on and dismounted from a lower side casing 55. Since the other configurations and actions are similar to those of the first embodiment which are described above, same reference numerals will be used for similar configurations, descriptions and illustrations are omitted or simplified, and in the following, points which are different from the first embodiment will be mainly described.

In the first embodiment which is described above, the configuration of the image forming system for sheet paper printing as shown in FIG. 1. However, the image forming system is not limited to a sheet paper printing machine, but it is also possible to apply to a continuous printing machine. In a case of a continuous printing machine, since a sheet is continuous from feeding to discharging, it is not necessary to continuously arrange conveying belts which convey a sheet as in a case of a sheet paper printing machine. Therefore, even in the drying module 3000A, the drying belt unit 3300, etc. as in the first embodiment is not necessary.

The drying module 3000A according to the embodiment includes the warm air blowing unit 51 similar to the first embodiment. As shown in FIG. 16, a main body portion 3100A of the drying module 3000A includes an upper door (upper side casing) 54 as a second casing and the lower side casing 55 as a casing and a first casing. In the embodiment, the warm air blowing unit 7 and the cold air blowing unit 3 are accommodated inside the lower casing 55. On the other hand, inside the upper door 23, a plurality of rollers 53 as a sheet conveyance portion are accommodated.

The upper door 54 is configured to open upward to the lower side casing 55. That is, the upper door 54 is rotatable around a supporting portion 3102A between a closed position in which the plurality of rollers 53 and the warm air blowing unit 51 are opposed each other and an open position in which the plurality of rollers 53 are spaced away from the warm air blowing unit 51 and the warm air blowing unit 51 is exposed.

In a case of the image forming system according to the embodiment, an image forming surface of a sheet is a surface on a lower side of the sheet with respect to a vertical direction, and the warm air blowing unit 51 is accommodated in the lower side casing 55 and blows warm air from a lower side upward. The warm air blowing unit 51 has the same configuration as the warm air blowing unit 7 according to the first embodiment, except it is configured to blow toward the upper side and is configured to be mounted on and dismounted from the lower side casing 55 by lifting the front side upward as described below.

A sheet conveying passage 52 through which a sheet is conveyed is provided between the warm air blowing unit 51 and the plurality of rollers 5, and the plurality of rollers 53 guide to convey the sheet by rotating in accordance with the sheet which is conveyed in the sheet conveying passage 52. Therefore, the plurality of rollers 53 include rotational axis lines which are parallel to a sheet width direction which intersects (“perpendicular to” in the embodiment) a conveying direction of each sheet and are arranged at intervals from each other with respect to the sheet conveying direction. And it is rotationally driven by contacting the sheet which is conveyed in the sheet conveying passage 52. Further, the plurality of rollers 53 support the sheet (continuous paper, etc.) while applying tension to it.

In this way, in a case of the embodiment, the warm air blowing unit 51 is arranged below the sheet conveying passage 52. Therefore, in a case that the warm air blowing unit 51 is replaced, as shown in FIG. 16, the upper door 54 which is provided with the plurality of rollers 53 is lifted to an upper portion and the sheet conveying passage 52 is opened. Since the warm air blowing unit 51 is mounted on the lower side casing 55 as described above, the warm air blowing unit 51 is configured to be removed from the lower side casing 55 while the back side of the warm air blowing unit 51 is a center of rotation, as shown in FIG. 17. A positioning method and a fixing method of the warm air blowing unit 51 and a replacing method which is accompanied with it are the same as in the first embodiment.

In a case of the embodiment, it is also easier to guarantee functions after component replacement, since the warm air blowing unit 51 is a unit basis whose function is guaranteed. Further, replacement operation of the warm air blowing unit 51 is performed safely and easily. Incidentally, instead of the warm air blowing unit 51 or in addition to the warm air blowing unit 51, a cold air blowing unit may be arranged on the lower side casing 55, and, in this case, cold air is blown from the lower side toward the sheet. A configuration of the cold air blowing unit for mounting on and dismounting from the lower side casing 55 is the same as the warm air blowing unit 51.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-085247 filed on May 24, 2023, which is hereby incorporated by reference herein in its entirety.

What is claimed is:

1. A drying device comprising:
a sheet conveyance portion configured to convey a sheet;
a warm air blowing portion disposed above with respect to a vertical direction and opposite to the sheet conveyance portion, and configured to blow a warm air from a nozzle on the sheet conveyed by the sheet conveyance portion;
a first casing configured to accommodate the warm air blowing portion; and
a second casing configured to accommodate the sheet conveyance portion,
wherein the first casing is movable to a closed position opposite to the sheet conveyance portion and an open position for opening the sheet conveyance portion,
wherein the first casing positioned in the closed position moves to the open position by being moved upward to the second casing with respect to the vertical direction, and
the warm air blowing portion is movable to the first casing in the vertical direction in a state in which the first casing is positioned in the open position.

2. A drying device according to claim 1, wherein the warm air blowing portion includes a blowing portion configured to blow an air, a passage portion through which the air blown from the blowing portion flows, a heating portion configured to heat the air flowing through the passage portion and a temperature detecting portion configured to detect a temperature of the air flowing through the passage portion.

3. A drying device according to claim 1, wherein the first casing positioned in the closed position moves to the open position by a front side of the first casing being raised in the vertical direction about a first rotation shaft along a conveyance direction of the sheet conveyance portion as a rotation center.

4. A drying device according to claim 3, further comprising a second rotation shaft provided along the conveyance direction and configure to permit the warm air blowing portion to rotate to the first casing,
wherein in a case in which the first casing is positioned in the open position, the warm air blowing portion moves to a first position where the warm air blowing portion is accommodated in the first casing and to a second position from the first position by a front side of the warm air blowing portion being moved downward about the second rotation shaft.

5. A drying device according to claim 4, wherein in a case the first casing is positioned in the open position and the warm air blowing portion is positioned in the second position, the warm air blowing portion is demountable from the first casing.

6. A drying device according to claim 5, wherein the warm air blowing positioned in the second position is substantially horizontal.

7. A drying device according to claim 4, further comprising a holding portion configured to hold the front side of the warm air blowing portion to the first casing in a state in which the warm air blowing is positioned in the first position.

8. A drying device according to claim 7, wherein the warm air blowing portion includes a lock portion capable of locking and rock releasing the holding portion on the front side of the warm air blowing portion.

9. A drying device according to claim 2, wherein the warm air blowing portion further includes a pressure detecting portion configured to detect a pressure of the air flowing through the passage portion.

10. A drying device according to claim 1, wherein the sheet conveyance portion includes a rotatable endless belt, a plurality of stretching rollers configured to stretch the belt and a belt heater configured to heat the belt, and
wherein the sheet conveyance portion conveys the sheet while heating the sheet by the belt.

11. A drying device according to claim 10, wherein the sheet conveyance portion further includes a sucking portion configured to suck an air, and
wherein the belt attracts the sheet to a surface thereof and conveys the sheet by the air being sucked by the sucking portion.
